(19) United States
(12) Patent Application Publication
(10) Pub. No.: US 2005/0047881 A1
(43) Pub. Date: Mar. 3, 2005

(54) Drive unit of a drilling machine

(75) Inventors: Peter Dallinger, Munchen (DE); Dieter Frey, Heubach (DE)

Correspondence Address: MICHAEL BEST & FRIEDRICH, LLP, 100 E WISCONSIN AVENUE, MILWAUKEE, WI, 53202, US

(73) Assignee: Rotwerk Elektrowerkzeuge und Handelsmarketing, Aschheim (DE)

(21) Appl. No.: 10/775,024

(22) Filed: Feb. 9, 2004

(30) Foreign Application Priority Data
Feb. 10, 2003 (DE) 203 02 053.7

(51) Int. Cl. B23B 47/16

(52) U.S. Cl. 408/128

(57) ABSTRACT

The present invention relates to a drive unit of a drilling machine, a drive with at least two drive wheels being provided in a drive housing and at least one endless drive being guided around the drive wheels. To improve a drive unit of this type in such a manner that, while having a structure that is as simple as possible, it operates in a functionally reliable way and requires little space, the drive housing in the area of at least one of the drive wheels comprises at least one bay-like bulge which extends over a circumferential section of the drive wheel near the drive wheel.

The present invention relates to a drive unit of a drilling machine comprising the features of the preamble of claim 1.

Generic drive units for drilling machines are known in practice, where a belt drive is enclosed with a large volume by a box-like housing. With the help of the large-volume enclosure, the housing is designed to fit differently designed drives. As a side effect, the large-volume enclosure permits an efficient air and heat exchange in the housing.

It is the object of the present invention to improve a generic drive unit for drilling machines such that, while having a structure that is as simple as possible, it operates in a functionally reliable manner and requires little space.

This object is achieved according to the invention with a drive unit for drilling machines comprising the features of claim 1.

With the bulge in the area of the drive wheel, the drive housing can be configured with a reduced volume in this area. At the same time, an air channel is formed between drive wheel and bulge. Due to the movement of the drive wheel and the endless drive, air flows into said air channel, so that an air throughput is created through said channel. The intensive air throughput ensures a cooling of drive wheel and endless drive and an air and heat exchange in the housing.

In a particularly preferred embodiment of the invention, at least one bulge may be provided at both longitudinal sides of the drive housing. As a result, the drive housing can respectively be configured with a reduced volume at both longitudinal sides in the area of the bulges. As a result of the two bulges, air channels are formed that supplement one another in their effect, so that the cooling effect created by the two bulges is greater than the cooling effect created individually by one of said bulges.

In a particularly advantageous embodiment of the invention, the bulge extends approximately arcuately near the drive wheel. An arcuate configuration of the bulge enables the bulge on the whole to easily approach the drive wheel. Furthermore, the resistance to flow through the air channel, which is also formed by the bulge, is reduced thanks to the round configuration.

In a development of the invention, the bay-like bulge in its extension near the drive wheel may be narrower in portions and extend at least towards a housing center in funnel-like fashion spaced apart from the drive wheel. The air channel is thereby configured to open towards the housing center in funnel-like fashion with the help of the bulge. This promotes a flow of air into the air channel, which leads to an increased air throughput. In the reverse case, an outflow of air in the manner of a diffuser is promoted, which also results in an increased air throughput.

Advantageously, an inner radius of the bay-like bulge may be larger than an outer radius of the drive wheel and may be eccentric thereto. As a result, the air channel, which is also formed by the bulge, is funnel-shaped. An inflow of air at the side of the funnel opening is promoted, which leads to an increased air throughput. On the other hand, this construction also promotes an outflow of air at the side of the funnel opening in the manner of a diffuser, which also leads to an increased air throughput Thanks to the configuration of the bulge in the manner of a circular arc, said bulge can be produced in a particularly simple way. Moreover, this leads to advantageous air resistances for the air channel formed by the bulge.

Preferably, the bay-like configuration extends at a distance between 5 and 65 mm, preferably between 8 and 28 mm, spaced apart from the drive wheel. With such distance ranges, the bulge, on the one hand, for a volume-reduced configuration of the drive housing in said area, can be configured to be guided close to the drive wheel. On the other hand, this yields advantageous cross-sectional ratios for the air channel formed by the bulge.

In a particularly preferred embodiment of the invention, the bay-like bulge extends on a circumferential portion between 30° and 130°, preferably 90°, of the drive wheel near said wheel. Within these angular ranges, a considerably volume-reduced drive housing, which can be configured to be guided close to the drive wheel, is obtained in the area of the bulge. Furthermore, an air channel of an adequate length is formed with such bulges.

In a particularly preferred development of the invention, the bulge may be equipped on an upper and/or a lower side with a roof-like transition portion which establishes a transition between an outer portion of the bulge extending along the circumference of the drive wheel and the area of the drive housing adjoining the bulge. The bulge can be configured with a transition at the upper and/or lower side in a simple and inexpensive manner. Moreover, this yields an enlarged cross-section of the air channel formed with the help of the bulge, which permits a correspondingly increased air throughput.

Particularly preferably, the transitional section may be formed at least sectionwise in the manner of a conical surface. With this form, the transitional section can be produced in a particularly easy way. Furthermore, the flow resistance in said area of the flow channel formed with the bulge is kept low.

Advantageously, the drive housing may be divided at least sectionwise, the division being provided in the area of the bulge above the transition portion of the lower side of the bulge. As a result, the drive housing can be made open without any impediment due to its undercut provided by the bulge.

In an advantageous development of the invention, an upper part of the drive housing can be pivoted towards a face of the drive housing. The drive housing can thereby be opened particularly easily due to its shape that is undercut by the provision of the bulge.

Advantageously, a rib-like profile may be provided on an inside of the housing of the bay-like bulge. Said rib-like profile reinforces the bulge with respect to mechanical loads and, in addition, ensures an additional swirling of the air flowing through the air channel formed with the bulge.

Separate protection is claimed for a drilling machine comprising a drive unit according to at least one of claims 1 to 12.

An embodiment of the invention is shown in the drawing, in which

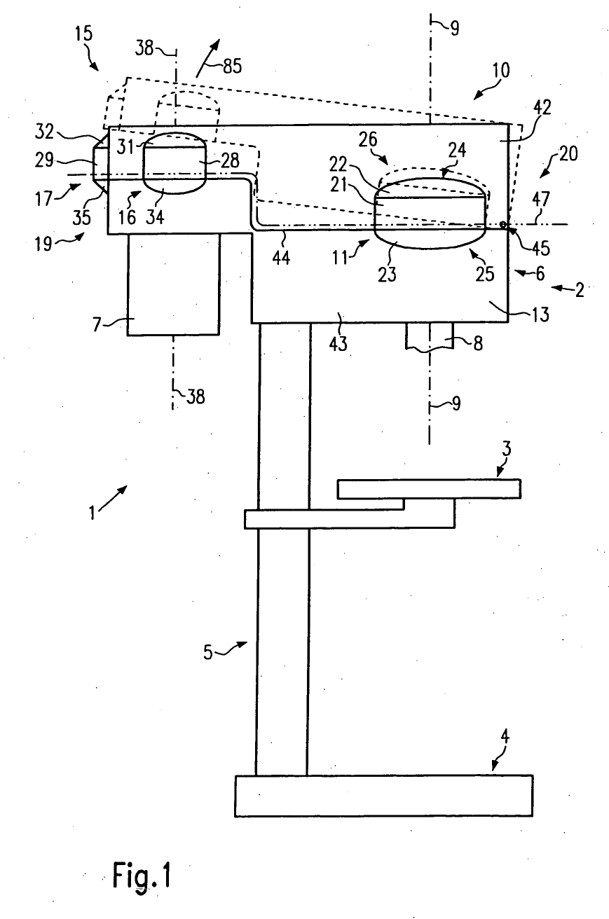

FIG. 1 is a view on a side of a drilling machine comprising a drive unit according to the invention;

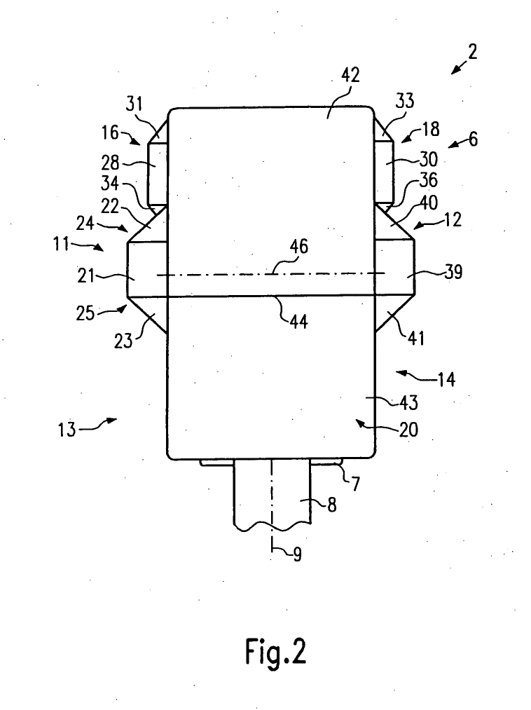

FIG. 2 is a view on a front side of the inventive drive unit of FIG. 1;

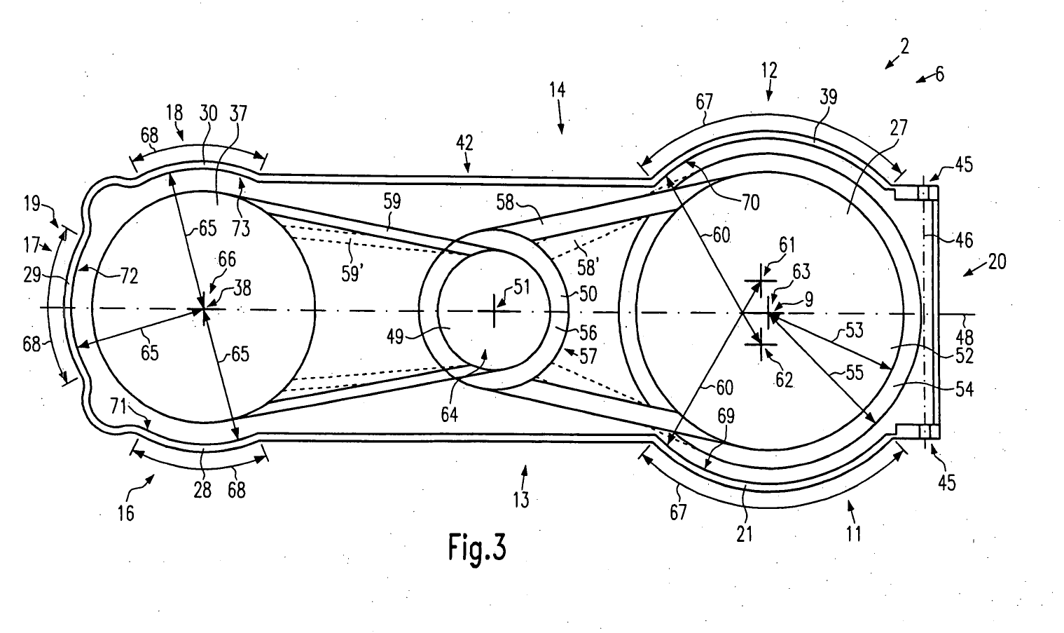

FIG. 3 is a schematic view on an upper side of the drive unit of FIG. 2, in a cutaway state; and

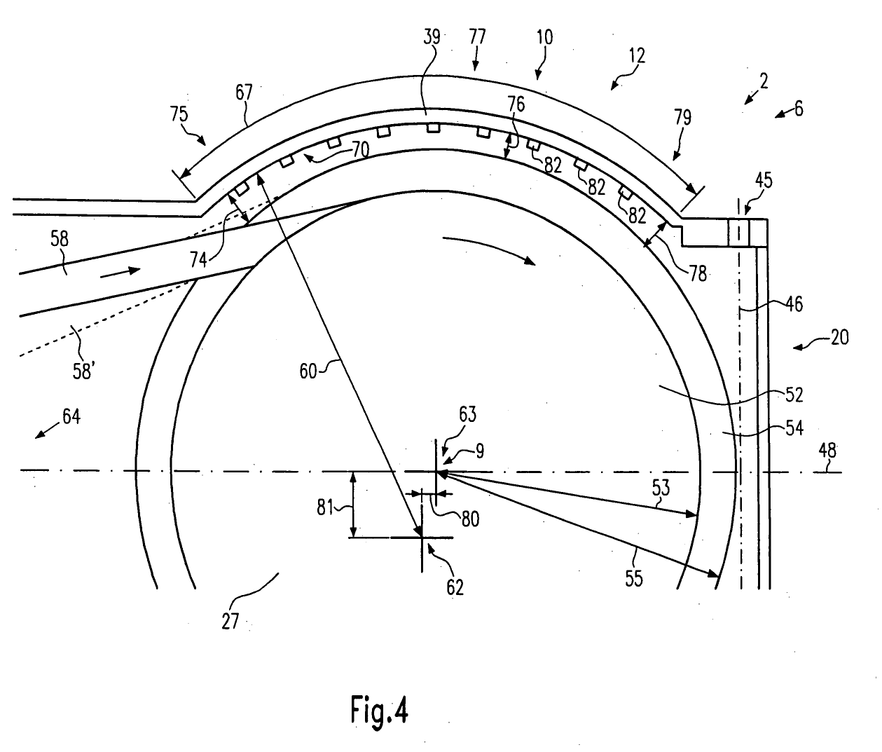

FIG. 4 is an enlarged section of the schematic illustration of FIG. 3.

Like numerals will always be used for like elements in the following. To avoid reiterative statements, reference is made to explanations that were already given or will still be given with respect to the respective elements.

FIG. 1 shows a drilling machine 1 with a drive unit 2, a worktable 3, a base 4, and an upright column 5. The drive unit 2 comprises a drive housing 6, a motor 7, and a work spindle 8 that is rotatable about a rotational axis 9.

In a front section 10, the drive housing 6 comprises two first and second bay-like bulges 11, 12 that are mirror-inverted. In the illustration of FIG. 1, it is only the first bay-like bulge 11 that is provided at a first longitudinal side 13. A third, fourth and fifth bay-like bulge 16, 17, 18 is provided on a rear section 15 of the drive housing 6. The illustration of FIG. 1 only shows the third bay-like bulge 16 provided at the first longitudinal side 13, and the fourth bay-like bulge 17 provided on a rear face 19.

The first bay-like bulge 11 has an outer portion 21 which is followed at an upper side 24 of the bulge 11 by an upper roof-like transition portion 22 and at a lower side 25 of the bulge 11 by a lower roof-like transition portion 23. Each of the roof-like portions 22, 23 forms a transition between the outer portion 21 and a portion 26 of the drive housing 6 adjoining the bulge 11. The transition portions 22, 23 are substantially formed as part of a conical surface.

Especially the outer portion 21 of the bulge 11 extends approximately in the manner of an arc approximately along a circumference of a first drive wheel provided inside the drive housing 6. The first drive wheel and the work spindle 8 are jointly rotatable about the first rotational axis 9.

Optionally, the arcuate configuration of the outer portion of the first bulge 11 may also be in the form of an arc with corners. The roof-like transition portions 22, 23 of the first bulge 11 are then formed in a corresponding way with corners, e.g. as part of a conical surface.

The second, third and fourth bay-like bulges are formed by analogy with the first and second bulges 11, 12 and thus have an outer portion 28, 29, 30, an upper roof-like transition portion 31, 32, 33 and a lower roof-like transition portion 34, 35, 36. The third, fourth and fifth bulges 16, 17, 18 extend each approximately along a circumference of a second drive wheel provided in the work housing 6. The second drive wheel and the motor 7 have a joint second axis of rotation 38. The second drive wheel has a smaller diameter than the first drive wheel. The third bay-like bulge 16 is mirror-inverted relative to the fifth bay-like bulge 18.

The third, fourth and fifth bulges 16, 17, 18 are each less broad relative to a direction transverse to the second rotational axis 38 than the first and second bulges 11, 12 relative to a direction transverse to the first rotational axis 9. As for a direction along the second rotational axis 38, the outer portion 28, 29, 30 of the first, fourth and fifth bulges 16, 17, 18 is higher than the outer portions 21, 39 of the third and second bulges 11, 12 relative to a direction along the first rotational axis 9.

The drive housing 6 has a first housing part 42 and a second housing part 43. The division between the first and second housing parts 42, 43 is made in the area of the bulges 11, 12, 16, 17, 18, each time above the lower roof-like transition portion 23, 41, 34, 35, 36. The division extends along the line 44 shown in FIG. 1. The division line extends around the whole drive housing 6.

Due to the division of the drive housing 6, the first housing part 42 can be detached from the second housing part 43, the first housing part 42 being guided past the first and second drive wheels 27, 37 without any impediment. In this embodiment of the invention, the drive housing 6 comprises hinge elements 45 which are provided on a front face 20. The hinge elements 45 enable the first housing part 42 to pivot in the direction of arrow 85 towards the front face 20. The hinge elements 45 are here provided near the division line 44, hingedly connecting the first and second housing parts 42, 43 to one another.

Optionally, the hinge elements may also be provided on a rear face 19 of the work housing 6 to enable the first housing part 42 to pivot towards the rear face 19.

FIG. 2 shows the drive unit 2 of the invention in a front view. What can here in particular be seen are the form of the upper and lower roof-like transition portions 22, 40, 31, 33, 23, 41, 34, 36 of the first, second, third and fifth bulges 11, 12, 16, 18 and of the outer portions 21, 39, 28, 30 thereof. Furthermore, as can be seen in the illustration of FIG. 2, the third and fifth bulges 16, 18 project from the respective longitudinal side 13, 14 of the drive housing 6 to a lesser degree than the first and second bulges 11, 12.

FIG. 2 shows a horizontal pivot axis 46 around which the hinge element 45 enables the first housing part 42 to pivot towards the front face 20.

FIG. 3 shows a schematic top view on the drive unit according to the invention, a part of the first housing part 42 having been cut off along a sectional line 47 as shown in FIG. 1.

According to the schematic view shown in FIG. 3, the configuration of the drive unit is in mirror symmetry with a longitudinal axis 48 of the drive unit 2. The first drive wheel 27, the second drive wheel 37 and the third and fourth drive wheels 49, 50 are provided in the drive unit, the longitudinal axis 48 extending through the rotational axes 9, 38, 51 of said wheels. The third and fourth drive wheels 49, 50 are provided on a shaft with the third rotational axis 51 and arranged in a position between the first and second drive wheels 27, 37, approximately centrally in the drive housing 6.

The first drive wheel 27 comprises a small drive member 52 with a small radius 53 and a large drive member 54 with a large radius 55. The fourth drive wheel 50 also comprises a large drive member 56 and a small drive member 57, the small drive member 57 being covered by the large drive member 56 in the illustration of FIG. 3.

A first endless drive 58 is guided over the first drive wheel 27 and the fourth drive wheel 50. According to the illustration of FIG. 3 the first endless drive 58 runs around the large drive member 56 of the fourth drive wheel 50 and the small drive member 52 of the first drive wheel 27. Alternatively, the first endless drive 58′ can also run around the small drive member 57 of the fourth drive wheel 50 and the large drive member 54 of the first drive wheel, as shown in broken lines.

The second drive wheel 37 and the third drive wheel 49 are each adjustable drive wheels around which a second endless drive 59 is guided. Both the second and the third drive wheels 27, 59 can adjust the diameter over which the second endless drive 59 is respectively running. The second endless drive 59 in a first diameter combination of the second and third drive wheels 27, 59 is shown in solid lines. The second endless drive 59′ according to a second diameter combination of the second and third drive wheels 37, 49 is shown in broken lines.

In the present embodiment of the invention, the drive wheels are pulleys and the endless drives are belts. Alternatively, chains and chain wheels may be used, also in part. It is also possible to configure the drive wheels and the endless drives each as gears.

The outer portions 31, 39 of the first and second bulges 11, 12 are configured to extend over a circumferential section of the first drive wheel 27 near said drive wheel 27. By analogy, the outer portions 28, 29, 30 of the third to fifth bulges 16, 17, 19 are configured to extend over a circumferential section of the second drive wheel 37 near said drive wheel 37.

The outer portions 21, 39 of the first and second bulges 11, 12 are made arcuate, each with a first radius 60. The centers 61, 62 of the radii 60 of the outer portions 21, 39 are each positioned in mirror-inverted fashion eccentric to a first center 63 of the first drive wheel 27. Accordingly, the shape of the first and second bulges 11, 12 is configured to be narrower in portions and to extend towards a housing center 64 in funnel-like fashion more spaced apart with respect to the first drive wheel 27. The first radii of said outer portions 21, 39 are larger than the large radius 55 of the first drive wheel 27.

The outer portions 28, 29, 30 of the third, fourth and fifth bulge 16, 17, 19 are formed with respectively equal second radii 65. The center of the second radii corresponds to a second center 66 of the second drive wheel 37. Accordingly, said outer portions 28, 29, 30 extend with a constant spacing from the second drive wheel 37.

Alternatively, the outer portions 21 and 39, as well as the outer portions 28, 29, 30, may be designed with respectively different radii.

The circumferential portion over which the bulges 21, 39, 28, 29, 30 extend along the respective drive wheel 27, 37 may be in the range between 30° and 130° with respect to the center 63, 66 of the respective drive wheel 27, 37. In the present embodiment, the circumferential portions 67 of the first and second bulges 11, 12 extend over a range of about 90° with respect to the first center 63 of the first drive wheel 27. The circumferential portions 68 of the third, fourth and fifth bulge 16, 17, 18 extend each over a range of about 55° with respect to the second center 66 of the second drive wheel 37.

The distance between a respective inner circumferential surface 69, 70, 71, 72, 73 of the bulges 11, 12, 16, 17, 18 and the respectively associated drive wheel 27, 37 may assume a value in the range of 5 to 65 mm, preferably 8 to 28 mm. In particular, smaller distance values may be used between the large drive member 54 of the first drive wheel 27 and the first and second bulges 11, 12, and larger distance values between the smaller drive member 52 of the first drive wheel 27 and the first and second bulges 11, 12.

FIG. 4 shows part of the front section 10 of the drive unit 2 shown in FIG. 3 on an enlarged scale. What can particularly clearly be seen in this figure is the distance of the second bulge 12 with respect to the first drive wheel 27, said bulge being narrower in portions and extending towards the housing center 64 in funnel-like fashion spaced apart from the drive wheel 27. A distance 74 between the inner surface 70 of the second bulge 12 and the first drive wheel 27 is maximum at the end of a portion 75 of the second bulge 12, which portion is at the side of the housing center. In the present embodiment, the distance 74 has a value of about 16 mm. A distance 76 between the inner surface 70 and the first drive wheel 27 is minimum in a center portion 77 of the second bulge 12. In the present embodiment, said distance 76 has a value of about 10 mm. A distance 78 at the end of a front-side portion 79 of the second bulge 12 is larger than the distance 76 in the center portion 77.

The described configuration of the distance between second bulge 12 and first drive wheel 27 is due to the eccentricity of the center 62 of the radius 60 of the second bulge relative to the center of the radius of the first drive wheel 27. A longitudinal value 80 of the eccentricity in the longitudinal direction with respect to the longitudinal axis 48 is here smaller than a transverse value 81 of the eccentricity in a direction transverse to the longitudinal axis 48. The longitudinal value 80 may here have values of up to about 10 mm in the present embodiment, preferably a value of about 5 mm. The transverse value 81 may assume values between about 15 and 25 mm, preferably a value of about 20 mm.

A rib-like profile with a number of ribs 82 is formed on the inner surface 70 of the second bulge 12. The ribs 82 are not shown in FIG. 3 for reasons of clarity.

On account of the mirror-inverted configuration of the bulge 11 relative to the second bulge 12, the above observations apply by analogy to the first bulge 11.

The function of the present embodiment will now be described.

Thanks to the provision of the bay-like bulges, the drive housing 6 may be particularly space-saving in the area of the first and second drive wheels 27, 37.

Furthermore, with the bulges air channels are formed between the respective bulge and the respective drive wheel. Due to the rotation of the drive wheels 27, 37 and the movement of the endless drives 58, 58′, 59, 59′, air is entrained and moved through the air channels. The correspondingly intensive air flow in the space narrowly surrounded by the drive wheels 27, 37 has a cooling effect on the drive wheels 27, 37 and the endless drives 58, 58′, 59, 59′.

According to the form of the bulges the air channels are made arcuate near the drive wheels 27, 37. As a result, the air flow is each time guided near the drive wheels 27, 37 and at a speed close to the respective circumferential speed of the drive wheels 27, 37.

With the help of the first, second, third and fifth bulges 11, 12, 16, 18, an approximately cross-wise flow through the drive housing 6 is effected due to the opening of said bulges towards the housing center 64. The air exchange is here particularly intensive.

A particularly strong air flow trough the air channels formed with the first and second bulges 11, 12 is realized by the funnel-like spacing of the first and second bulges 11, 12 relative to the first drive wheel 27. According to the running direction 83 of the first endless drive 58 as shown in FIG. 4 and the corresponding rotational direction 84 of the first drive wheel 27, air in the portion 75 at the side of the housing center is compressed and particularly strongly sucked towards the center portion 77 and passed therethrough at an accelerated speed. The air exit is accelerated in the air channel formed in mirror-inverted fashion with respect to the first bulge 11. The funnel-like opening of the air channel towards the housing center 63 acts as a diffuser.

The ribs 82 which are provided on the inner walls 69, 70 of the first and second bugles 11, 12 cause a swirling of the air in the respective air cannel. The cooling effect of the air flowing therethrough is thereby enhanced further.

1. A drive unit (2) of a drilling machine (1), with a drive having at least two drive wheels (27, 37) being provided in a drive housing (6) and at least one endless drive (58, 59) being guided around the drive wheels,
characterized in
that the drive housing in the area of at least one of the drive wheels comprises at least one bay-like bulge (11, 12, 16, 17, 18) which extends over a circumferential section (67, 68) of the drive wheel near the drive wheel.

2. The drive unit according to claim 1,
characterized in
that at least one bulge (11, 12, 16, 18) is provided at both longitudinal sides (13, 14) of the drive housing (6).

3. The drive unit according to any one of claims 1 or 2,
characterized in
that the bulge (11, 12, 16, 17, 18) extends approximately arcuately near the drive wheel (27, 37).

4. The drive unit according to at least one of the preceding claims,
characterized in
that the bay-like bulge (11, 12, 16, 17, 18) in its extension near the drive wheel (27, 37) is narrower in portions and extends at least towards a housing center (64) in funnel-like fashion spaced apart from the drive wheel.

5. The drive unit according to at least one of the preceding claims,
characterized in
that an inner radius (60) of the bay-like bulge (11, 12) is larger than an outer radius (55) of the drive wheel (27) and is eccentric-thereto.

6. The drive unit according to at least one of the preceding claims,
characterized in
that the bay-like bulge (11, 12, 16, 17, 18) extends spaced-apart from the drive wheel (27, 37) at a distance between 5 mm and 65 mm, preferably between 8 mm and 28 mm.

7. The drive unit according to at least one of the preceding claims,
characterized in
that the bay-like bulge (11, 12, 16, 17, 18) extends on a circumferential portion (67, 68) between 30° and 130°, preferably about 90°, of the drive wheel (27, 37) near said wheel.

8. The drive unit according to at least one of the preceding claims,
characterized in
that the bulge (11) is provided on an upper and/or a lower side (24, 25) of a roof-like transition portion (22, 23), which establishes a transition between an outer portion (21) of the bulge (11) extending along the circumference of the drive wheel (27) and the portion (26) of the drive housing (6) adjoining the bulge.

9. The drive unit according to claim 8,
characterized in
that the transition portion (22, 23) is shaped in the form of a conical surface at least sectionwise.

10. The drive unit according to any one of claims 8 or 9,
characterized in
that the drive housing (6) is divided at least sectionwise, the division being provided in the area of the bulge (11) above the transition portion (23) of the lower side (25) of the bulge (11).

11. The drive unit according to at least one of the preceding claims,
characterized in
that an upper member (42) of the drive housing (6) is pivotable to a face (20) of the drive housing.

12. The drive unit according to at least one of the preceding claims,
characterized in
that a rib-like profile (82) is provided on an inner housing side (70) of the bay-like bulge (11).

13. A drilling machine (1) comprising a drive unit (2) according to at least one of the preceding claims.
